(19) United States
(12) Patent Application Publication
(10) Pub. No.: US 2014/0070497 A1
(43) Pub. Date: Mar. 13, 2014

(54) SLIDE RING SEAL ARRANGEMENT WITH SPRING WASHER

(71) Applicants: Ferdinand Werdecker, Walchensee (DE); Andreas Fesl, Otterfing (DE); Thomas Keller, Geretsried (DE); Peter Feigl, Hoehenrain (DE)

(72) Inventors: Ferdinand Werdecker, Walchensee (DE); Andreas Fesl, Otterfing (DE); Thomas Keller, Geretsried (DE); Peter Feigl, Hoehenrain (DE)

(73) Assignee: CARL FREUDENBERG KG, Weinheim (DE)

(21) Appl. No.: 13/980,343

(22) PCT Filed: Jan. 17, 2012
(86) PCT No.: PCT/EP2012/000198

§ 371 Date: Aug. 27, 2013

(30) Foreign Application Priority Data
Jan. 19, 2011 (DE) 10 2011 008 927.6

(51) Int. Cl. F16J 15/34

(52) U.S. Cl. CPC F16J 15/3452
USPC 277/500

(57) ABSTRACT

A slide ring seal arrangement including a rotating slide ring (2), a static slide ring (3) and a preload device for preloading at least one of the slide rings, wherein the preload device includes a spring washer (7) with a basic body (70), with at least one spring bar (71) and with at least one engagement region (72) provided on the end of the spring bar (71), wherein the spring bars (71) run in the circumferential direction of the spring washer (7), and wherein the engagement region (72) is in engagement with a recess (30) provided on the slide ring in order to exert on the slide ring a preload force (F) acting in the axial direction (X-X).

### CROSS-REFERENCE TO RELATED APPLICATIONS

This application is a National Stage of International Application No. PCT/EP2012/000198, filed Jan. 17, 2012 (now WO 2012/097977A1), which claims priority to German Application No. 10 2011 008 927.6, filed Jan. 19, 2011. The entire disclosures of each of the above applications is are incorporated herein by reference.

### FIELD

The present disclosure concerns a slide-ring seal arrangement with a rotating and a stationary slide-ring as well as a spring washer as a preloading device for at least one of the slide rings.

### BACKGROUND AND SUMMARY

Slide-ring seal arrangements are known from prior art in various embodiments. Here the spring of a slide ring is used to provide the closing force needed for the slip plane without which the slide-ring seal would open up, due to the absence of a compressive load. An example of such a preloading arrangement is known from DE 20 2008 011 032 U1, in which several cylindrical helical screws distributed on the circumference exert a preloading force on a pressure-transfer ring, which is in contact with the slide ring. The necessary initial, axial stressing force is thereby applied. To receive the helical screws, however, a plurality of pockets and/or recesses is necessary, whereby manufacture of the slide-ring seal becomes expensive. Furthermore, with preloading arrangements that are disposed on a rotating slide ring, the possibility of wear additionally arises, due to the relative motions of the rotating slide ring and torque pins, which transfer rotation to the slide ring.

For that reason, it is a task of the present disclosure to provide a slide-ring seal arrangement that makes the improved spring of slide rings possible, with a simple construction and cost-effective fabrication.

The slide-ring seal arrangement according to the present disclosure exhibits as a preloading unit a spring washer with at least one spring bar and a mating area disposed on a free end of the spring bar. The spring bars run in the circumferential direction of the spring washer. The spring bar is connected to a body foundation of the spring washer and provides a spring force in an axial direction of the slide-ring seal arrangement. The mating area of the spring washer is at the same time in contact with a recess provided on the slide ring, in order to exert a preloading force on the slide ring in an axial direction. According to the disclosure, a single component that is cost-effective and simple to manufacture is consequently necessary as a preloading device. Furthermore, in particular, the overall axial length of the slide-ring seal arrangement is also significantly shortened by means of the spring washer, because the spring washer exhibits only a relatively small thickness in the axial direction.

It is especially preferred that the spring washer be a one-piece component, in particular a punch-and-bend component, preferably made of spring steel. The spring washer can thereby be manufactured very cost-effectively, and assembly of the spring washer is also possible very simply. Preferably, the spring bars are easily bent toward a plane on which the spring washer lies.

It is further preferred that the recess in the slide ring be constructed in the outer circumference of the slide ring. The main body of the slide ring can thereby be free of drilled holes or recesses or the like, and the mating area of the spring washer mates with the recess formed at the outer circumference. The recess at the outer circumference of the slide ring is preferably a groove running in an axial direction of the slide ring, preferably a continuous groove.

According to a further preferred embodiment, the spring washer includes a plurality of spring bars with mating areas; especially preferred are three or four spring bars. A uniform preloading-force arrangement can thereby result over the extent of the slide ring.

It is further preferred that the spring bar exhibit a graduated spring action. The graduated spring action can, for instance, be provided first at a specific, pre-determined temperature. The spring bar is made out of a shape-memory metal for this, for example, which metal changes its spring properties upon reaching a pre-determined temperature.

In order to provide spring washers with different spring properties as cost-effectively as possible, the spring bar preferably exhibits a coating, in which the coating can be a partial coating, that is, be partly coated, or a full coating, and/or spring bars are provided with different widths and/or spring bars are provided with different overall lengths. By means of the aforementioned measures described, individual adjustment of the desired, preloading force can be provided, whereby, with a plurality of spring bars, individual spring bars can be constructed differently. In addition, the spring bars can also achieve a different preloading force by variously selecting a material.

It is further preferred that a form-fit connection exist between the mating area on the spring bar and the recess in the slide ring. Play is hereby avoided between the mating area and the recess, so that no wear can occur at the form-fit connection during operation. Furthermore, using the preloading device on a rotating slide ring, besides the preloading function, a transfer of torque from a rotating component through the preloading device to the rotating slide ring can be made possible securely and loss-free. A further advantage here is that the form-fit connection allows the rotating slide ring to turn in both rotation directions without additional expense being necessary. In particular, the service life of the spring washer is thereby lengthened significantly.

Preferably, the spring bars exhibit a constant width in the radial direction of the spring washer. Excessive loads on the spring bars are hereby particularly avoided.

What is more, the preloading device according to the invention can be used on both a stationary slide ring and a rotating slide ring. If necessary, the preloading device can also be used on both slide rings at the same time.

It is further preferred that the preloading device be in direct contact with the slide ring. As a result of this, an intermediate pressure-transfer ring or the like can be omitted.

The spring washer according to the present disclosure is preferably constructed as a closed ring. The spring bars are preferred to be provided on an inner circumference of the spring washer.

For especially secure mating with the slide ring, the mating areas of the spring bars are preferably bent, particularly at an angle of about 90°. Consequently, the mating areas run essentially in an axial direction. Furthermore, undesirable dragging of the stationary slide ring due to the rotation of the rotating slide ring can be reliably and simply prevented.

It is further preferred that the mating areas of the spring bars exhibit an additional bend at the very end of the mating areas. Additional stiffening of the free end of the mating areas is thus attained. Further preferred is a mating area with the additional bend in a wall area of the recess. In particular, locking the spring bars and consequently the spring washer into position with respect to the slide ring that exhibits the recess can be achieved.

Preferably, the spring bars are formed with the mating areas such that one edge formed by the recess in the slide ring is not in contact with a part of the spring washer. Damage to the edge during operation of the slide-ring seal arrangement is thereby avoided, because there is no contact between the edge and part of the spring washer.

Further preferred are mating areas provided at the end of the spring bars that are all directed in the same circumferential direction on the spring washer. A simpler and more symmetrical construction can thereby be attained. To introduce a uniform force, the spring bars are preferably disposed respectively at equal distances apart in a circumferential direction.

According to a preferred alternative of the present disclosure, a first group of spring bars and a second group of spring bars are provided on the spring washer. The first group of spring bars is directed in a first circumferential direction for the spring washer and the second group of spring bars is directed in the second, opposite, circumferential direction. What is more, the geometric embodiments of the spring bars of both groups are preferably the same. Due to this embodiment of the spring washers with two groups of spring bars, use of the present disclosure is possible in applications in which the rotation direction of a rotating component is reversed during operation. Then in particular, the mating areas of the spring bars prevent dragging of the stationary slide ring in the two rotation directions.

In addition, preferably several openings are provided in the spring washer for a fastening element to pass through, such as, for instance, a screw or the like. It is also preferably possible for the mating area at the end of the spring bar to be twisted in a direction toward the middle of the spring washer, preferably by about 90°.

### DRAWINGS

A preferred embodiment example of the present disclosure is described next in detail, with reference to the accompanying drawings. Shown herewith are:

FIG. 1 is a schematic, sectional view of a slide-ring seal arrangement according to a first embodiment,

FIG. 2 is a schematic, plan view of a spring washer from FIG. 1,

FIG. 3 is a schematic, perspective, partial view of the spring washer from FIG. 2,

FIG. 4 is a schematic side view of a slide ring with parts of the spring washer from FIG. 1,

FIG. 5 is a schematic depiction of part of a slide-ring seal arrangement according to a second preferred embodiment, and

FIG. 6 is a schematic depiction of a spring washer according to a third embodiment.

### DETAILED DESCRIPTION

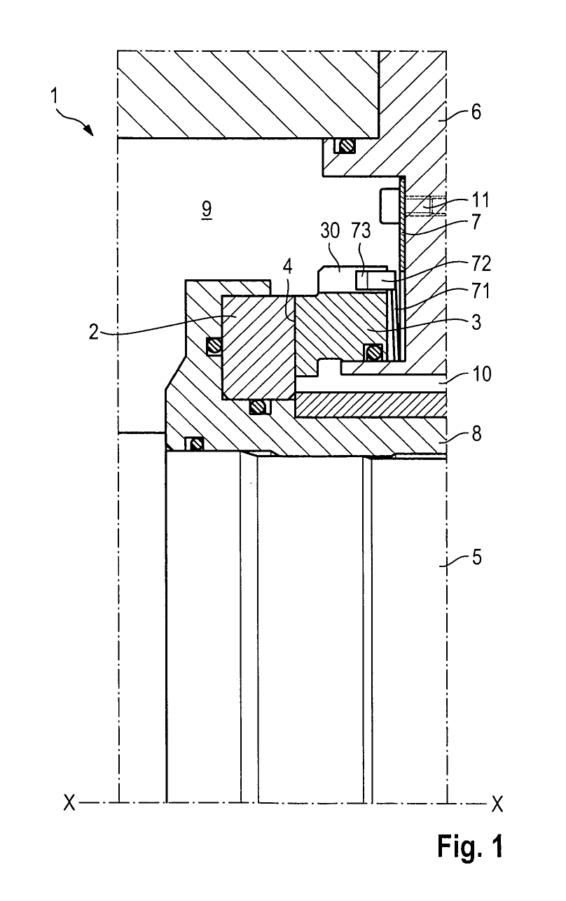

The slide-ring seal arrangement 1 shown in FIGS. 1 through 4 according to a first preferred embodiment includes a rotating slide ring 2 and a stationary slide ring 3, which define a sealing gap 4 between them. The slide rings thereby seal off a product area 9, for instance, from the area open to the atmosphere 10. What is more, the rotating slide ring 2 is held by a shaft sleeve 8 mounted on a rotating shaft 5, which transfers the rotation of the shaft 5 to the rotating slide ring 2. The stationary slide ring 3 is disposed on a stationary component 6 and is provided as axially movable. The stationary slide ring 3 is initially stressed, by means of a spring washer 7 as a preloading device, in an axial direction X-X counter to the rotating slide ring 2.

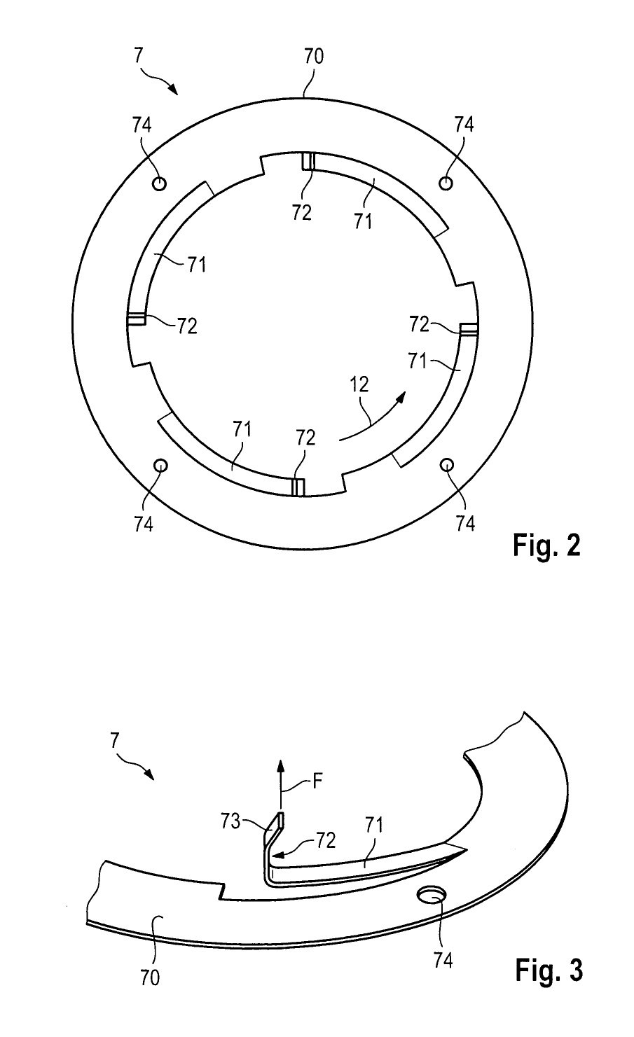

The spring washer 7 is represented in detail in FIGS. 2, 3, and 4 and includes a closed, annular, body foundation 70, on whose inner circumference are disposed several spring bars 71. Four spring bars 71 are provided in this embodiment example. The spring bars 71 are formed in one piece with the body foundation 70 and exhibit one mating area 72 each at their free ends. As is apparent from FIG. 1, the mating area 72 mates with a recess provided at an outer circumference 30 of the stationary slide ring 3. A form-fit connection can thereby be provided between the mating area 72 and the recess 30. The recess 30 is provided as a groove passing through in an axial direction X-X. The spring bars 71 and the mating areas 72 exhibit a constant width circumferentially.

The spring washer 7 is fastened by means of several screws 11 to the stationary component 6. Through-hole openings 74 are formed for this in the body foundation 70. The spring washer 7 is preferably manufactured out of spring steel, whereby the spring washer 7 is preferably manufactured as a punch-and-bend component. The spring bars 71 here can be punched in one step out of the annular body foundation 70, and then the free ends of the spring bars 71 are bent in order to form the mating areas 72. Punching out the spring bars 71 made of spring steel consequently can cause a preloading force F acting on the stationary slide ring 3 in an axial direction X-X. As is 3 apparent from FIG. 3, a bend of about 90° can then result and in addition a second bend 73 of the very end of the mating area 72 as well. Consequently, the spring bars and the mating areas can be rapidly and cost-effectively manufactured from the annular body foundation 70.

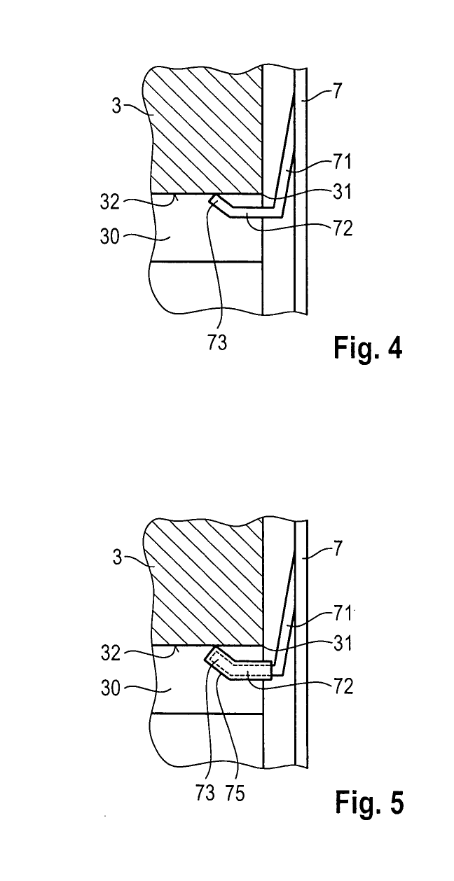

By bending the mating areas 72 away from the spring bars 71, secure locking of the spring washer into position on the stationary slide ring 3 can be achieved. What is more, the second bend 73 at the very end of the mating area 72 fits tightly into the groove 30 of the stationary slide ring 3, seen inclined in an axial direction. The end of the second bend 73 then fits tightly to a wall area 32 of the groove 30. In order not to impair the centering of the stationary slide ring 3, a gap exists in a radial direction toward the floor surface of the groove 30 (cf. FIG. 1). The spring bars and mating areas also do not touch edges 31 of the groove 30 (cf. FIG. 4). Here in particular, chipping off of material can be prevented at the edges 31 of the stationary slide ring 3, as can occur in solutions applied in prior art using a pin. In addition, introduction of force can result from the spring washer 7 to the stationary slide ring 3 in an axial direction X-X roughly in the middle of the groove. As is apparent from FIG. 2, furthermore, the mating areas 72 provided at the ends of the spring bars 71 are all directed in the same circumferential direction 12 of the spring washer 7. What is more, the spring bars 71 are disposed at equal distances apart in a circumferential direction.

The spring bars 71 consequently exert a preloading force F on the stationary slide ring 3 over the mating areas 72 in an axial direction X-X. In this embodiment example, the spring bars 71 exhibit the same respective width in a radial direction of the spring washers 7 and also the same length in the circumferential direction. In order to provide other spring constants at that time for the spring bars 71, however, variation in the overall length and/or width in the radial direction of the spring bars can be made. It is also further possible to provide a coating for the spring bars or to introduce additional sharp bends in the spring bars 71. A desirable combination of the measures described can thereby be carried out in order to provide different spring constants for the spring bars.

It may be further noted that the spring washer 7 can also be used on the rotating slide ring 2, in which, in particular, yet another function is possible, transferring torque from the shaft 5 to the rotating slide ring 2 via the spring washer 7.

FIG. 5 shows a spring washer 7 according to a second embodiment, which essentially corresponds to the first embodiment example. As is apparent from FIG. 5, in the second embodiment example, a protective coat 75 is additionally disposed over the free end of the mating area 72. What is more, the protective coat 75 covers both the second bend 73 and the region of the mating area 72 running in an axial direction. The protective coat is preferably made of plastic and prevents a sharp end-edge from burrowing into a wall 32 of the groove at the second bend 73 during operation. Damage to the stationary slide ring 3 is thereby avoided, and a constant, preloading force can be introduced throughout the entire service life of the spring washer 7. The protective coat 75 is preferably sprayed onto the free end of the mating area 72. Consequently, protection from wear is provided in a simple and cost-effective manner.

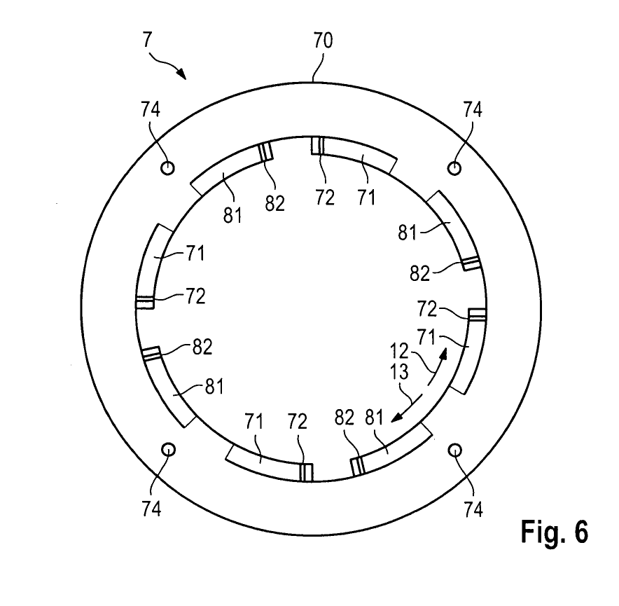

FIG. 6 shows a spring washer 7 according to a third embodiment, in which identical or functionally identical parts are designated by the same reference numbers as in the first embodiment example. In contrast to the first embodiment example, a first group of spring bars 71 and a second group of spring bars 81 are provided in the third embodiment. What is more, the first group of spring bars 71 and mating areas 72 is directed in a first circumferential direction 12. The second group of spring bars 81 with mating areas 82 is directed in a second circumferential direction 13, opposite to the first circumferential direction 12. Using this embodiment of the spring washer 7, in particular, this can be used for applications in which a rotating component, such as a shaft, for instance, is operated in two different rotation directions. Using both groups of spring bars 71, 81, in particular, a relative motion between the spring washer 7 and the stationary slide ring can be avoided during a reversal of direction of the rotating component, because with a directional reversal of the rotating component, the rotating slide ring exerts a torque on the stationary slide ring. The second group of spring bars 81 then prevents dragging of the stationary slide ring in the reversed rotation direction, whereby, in particular, chipping or other damage to the stationary slide ring can be avoided.

### REFERENCE LIST

1 Slide-ring seal arrangement
2 Rotating slide ring
3 Stationary slide ring
4 Sealing gap
5 Shaft
6 Stationary component
7 Spring washer
8 Shaft sleeve
9 Product area
10 Area open to atmosphere
11 Screws
12 First circumferential direction
13 Second circumferential direction
30 Recess
31 Edge
32 Wall
70 Annular body foundation
71 Spring bars
72 Mating area
73 Second bend
74 Through-hole opening
75 Protective coat
81 Spring bars
82 Mating area
F Preloading force
X-X Axial direction

1. A slide-ring seal arrangement, including:
a rotating slide ring (2),
a stationary slide ring (3), and
a preloading device for initially stressing at least one of the slide rings,
wherein the preloading device includes a spring washer (7) with a body foundation (70), at least one spring bar (71), and at least one mating area (72) provided at an an end of the spring bar (71),
wherein the at least one at least one spring bar (71) runs in a circumferential direction of the spring washer (7), and
wherein the mating area (72) is a recess (30) provided with a slide ring, in order to exert a preloading force (F) acting on the slide ring in an axial direction (X-X).

2. The slide-ring seal arrangement according to claim 1, wherein the spring washer (7) is provided as a one-piece, punch-and-bend component.

3. The slide-ring seal arrangement according to claim 1, wherein the recess (30) is formed at an outer circumference of the slide ring as a groove running in an axial direction (X-X).

4. The slide-ring seal arrangement according to claim 1, wherein said spring washer includes a plurality of spring bars (71) with one mating area (72) each.

5. The slide-ring seal arrangement according to claim 1, wherein the at least one spring bar (71) provides a graduated spring action.

6. The slide-ring seal arrangement according to claim 1, further comprising a form-fit closure between the mating area (72) and the recess (30) in the slide ring.

7. The slide-ring seal arrangement according to claim 4, wherein the spring bars (71) running in a circumferential direction exhibit a constant width in the radial direction.

8. The slide-ring seal arrangement according to claim 1, wherein the spring washer (7) is in direct contact with the slide ring.

9. The slide-ring seal arrangement according to claim 4, wherein the spring bars (71) are formed at the inner circumference of the spring washers (7).

10. The slide-ring seal arrangement according to claim 1, wherein the mating area (72) is bent away from the spring bar (71).

11. The slide-ring seal arrangement according to claim 1, wherein the mating area (72) exhibits an additional bend (73) at the very end of the mating area.

12. The slide-ring seal arrangement according to claim 11, wherein the additional bend (73) fits tightly to a wall area of the recess (30).

13. The slide-ring seal arrangement according to claim 1, wherein an edge formed by the recess (30) in the slide ring is not in contact with the spring washer (7).

14. The slide-ring seal arrangement according to claim 1, wherein the mating areas (72) provided at the end of the spring bars (71) are all directed in the same circumferential direction (12) of the spring washer (7).

15. The slide-ring seal arrangement according to claim 1, wherein the spring washer (7) includes a first group of spring bars (71) with mating areas (72) that are directed in a first circumferential direction (12) of the spring washer (7), and a second group of spring bars (81) with mating areas (82) that are directed in a second circumferential direction (13).
